(19) United States
(12) Patent Application Publication
(10) Pub. No.: US 2011/0240176 A1
(43) Pub. Date: Oct. 6, 2011

(54) HIGH-STRENGTH COLD-ROLLED STEEL SHEET HAVING EXCELLENT FORMABILITY, HIGH-STRENGTH GALVANIZED STEEL SHEET, AND METHODS FOR MANUFACTURING THE SAME

(75) Inventors: Shinjiro Kaneko, Tokyo (JP); Yoshiyasu Kawasaki, Tokyo (JP); Tatsuya Nakagaito, Tokyo (JP); Saiji Matsuoka, Tokyo (JP)

(73) Assignee: JFE STEEL CORPORATION, Tokyo (JP)

(21) Appl. No.: 13/131,758

(22) PCT Filed: Nov. 27, 2009
(86) PCT No.: PCT/JP2009/070367

§ 371 Date: May 27, 2011

(30) Foreign Application Priority Data
Nov. 28, 2008 (JP) 2008-303289
Mar. 31, 2009 (JP) 2009-083829
Nov. 18, 2009 (JP) 2009-262503

(51) Int. Cl. C21D 8/02; C22C 38/18; C22C 38/00; C22C 38/22; C21D 11/00; B32B 15/01

(52) U.S. Cl. 148/503; 148/333; 148/330; 148/334

(57) ABSTRACT

A high-strength cold-rolled steel sheet and high-strength galvanized steel sheet has a TS of 1180 MPa or more and excellent formability including stretch flangeability and bendability. The high-strength cold-rolled steel sheet contains 0.05% to 0.3% C, 0.5% to 2.5% Si, 1.5% to 3.5% Mn, 0.001% to 0.05% P, 0.0001% to 0.01% S, 0.001% to 0.1% Al, 0.0005% to 0.01% N, and 1.5% or less Cr (including 0%) on a mass basis, the remainder being Fe and unavoidable impurities.

### RELATED APPLICATIONS

This is a §371 of International Application No. PCT/JP2009/070367, with an international filing date of Nov. 27, 2009 (WO 2010/061972 A1, published Jun. 3, 2010), which is based on Japanese Patent Application Nos. 2008-303289, filed Nov. 28, 2008, 2009-083829, filed Mar. 31, 2009, and 2009-262503, filed Nov. 18, 2009, the subject matter of which is incorporated by reference.

### TECHNICAL FIELD

This disclosure relates to high-strength cold-rolled steel sheets and high-strength galvanized steel sheets, having excellent formability, suitable for structural parts of automobiles. The disclosure particularly relates to a high-strength cold-rolled steel sheet and high-strength galvanized steel sheet having a tensile strength TS of 1180 MPa or more and excellent formability including stretch flangeability and bendability and also relates to methods for manufacturing the same.

### BACKGROUND

In recent years, high-strength steel sheets having a TS of 780 MPa or more and a small thickness have been actively used for structural parts of automobiles for the purpose of ensuring the crash safety of their occupants and for the purpose of improving fuel efficiency by automotive lightening. In particular, attempts have been recently made to use extremely high-strength steel sheets with a TS of 1180 MPa or more.

However, the increase in strength of a steel sheet usually leads to the reduction in stretch flangeability or bendability of the steel sheet. Therefore, there are increasing demands for high-strength cold-rolled steel sheets having high strength and excellent formability and high-strength galvanized steel sheets having corrosion resistance in addition thereto.

To cope with such demands, for example, Japanese Unexamined Patent Application Publication No. 9-13147 discloses a high-strength galvannealed steel sheet which has a TS of 800 MPa or more, excellent formability, and excellent coating adhesion and which includes a galvannealed layer disposed on a steel sheet containing 0.04% to 0.1% C, 0.4% to 2.0% Si, 1.5% to 3.0% Mn, 0.0005% to 0.005% B, 0.1% or less P, greater than 4N to 0.05% Ti, and 0.1% or less Nb on a mass basis, the remainder being Fe and unavoidable impurities. The content of Fe in the galvannealed layer is 5% to 25%. The steel sheet has a microstructure containing a ferritic phase and a martensitic phase. Japanese Unexamined Patent Application Publication No. 11-279691 discloses a high-strength galvannealed steel sheet having good formability. The galvannealed steel sheet contains 0.05% to 0.15% C, 0.3% to 1.5% Si, 1.5% to 2.8% Mn, 0.03% or less P, 0.02% or less S, 0.005% to 0.5% Al, and 0.0060% or less N on a mass basis, the remainder being Fe and unavoidable impurities; satisfies the inequalities (Mn %)/(C %)≧15 and (Si %)/(C %)≧4; and has a ferritic phase containing 3% to 20% by volume of a martensitic phase and a retained austenitic phase. Japanese Unexamined Patent Application Publication No. 2002-69574 discloses a high-strength cold-rolled steel sheet and high-strength plated steel sheet having excellent stretch flangeability and low yield ratio. The high-strength cold-rolled steel sheet and the high-strength plated steel sheet contain 0.04% to 0.14% C, 0.4% to 2.2% Si, 1.2% to 2.4% Mn, 0.02% or less P, 0.01% or less S, 0.002% to 0.5% Al, 0.005% to 0.1% Ti, and 0.006% or less N on a mass basis, the remainder being Fe and unavoidable impurities; satisfy the inequality (Ti %)/(S %)≧5; have a martensite and retained austenite volume fraction of 6% or more; and satisfy the inequality α≦50000×{(Ti %)/48+(Nb %)/93+(Mo %)/96+(V %)/51}, where α is the volume fraction of a hard phase structure including a martensitic phase, a retained austenitic phase, and a bainitic phase. Japanese Unexamined Patent Application Publication No. 2003-55751 discloses a high-strength galvanized steel sheet having excellent coating adhesion and elongation during molding. The high-strength galvanized steel sheet includes a plating layer which is disposed on a steel sheet containing 0.001% to 0.3% C, 0.01% to 2.5% Si, 0.01% to 3% Mn, and 0.001% to 4% Al on a mass basis, the remainder being Fe and unavoidable impurities, and which contains 0.001% to 0.5% Al and 0.001% to 2% Mn on a mass basis, the remainder being Zn and unavoidable impurities, and satisfies the inequality 0≦3−(X+Y/10+Z/3)−12.5×(A−B), where X is the Si content of the steel sheet, Y is the Mn content of the steel sheet, Z is the Al content of the steel sheet, A is the Al content of the plating layer, and B is the Mn content of the plating layer on a mass percent basis. The steel sheet has a microstructure containing a ferritic primary phase having a volume fraction of 70% to 97% and an average grain size of 20 μm or less and a secondary phase, such as an austenite phase or a martensitic phase, having a volume fraction of 3% to 30% and an average grain size of 10 μm or less.

For the high-strength cold-rolled steel sheets and the high-strength galvanized steel sheets disclosed in JP '147, JP '691, JP '574 and JP '751, excellent formability including stretch flangeability and bendability cannot be achieved if attempts are made to achieve a TS of 1180 MPa or more.

It could therefore be helpful to provide a high-strength cold-rolled steel sheet and high-strength galvanized steel sheet having a TS of 1180 MPa or more and excellent formability including stretch flangeability and bendability and to provide methods for manufacturing the same.

### SUMMARY

We thus provide:
A TS of 1180 MPa or more and excellent formability including stretch flangeability and bendability can be achieved such that a composition satisfies a specific correlation and the following microstructure is created: a microstructure containing a ferritic phase and a martensitic phase, the area fraction of the martensitic phase in the microstructure being 30% or more, the quotient (the area occupied by the martensitic phase)/(the area occupied by the ferritic phase) being greater than 0.45 to less than 1.5, the average grain size of the martensitic phase being 2 μm or more.
The microstructure can be obtained such that annealing is performed under conditions including heating to a temperature not lower than the Ac₁ transformation point at an average heating rate of 5° C./s or more, heating to a specific temperature which depends on the composition, soaking at a temperature not higher than the Ac₃ transformation point for 30 s to 500 s, and cooling to a temperature of 600° C. or lower at an average cooling rate of 3° C./s to 30° C./s or in such a manner that annealing is performed under conditions including the same heating and soaking conditions as those described above and cooling to a temperature of 600° C. or lower at an average cooling rate of 3° C./s to 30° C./s and hot dip galvanizing is then performed.

Our high-strength cold-rolled steel sheets have excellent formability. The high-strength cold-rolled steel sheet contains 0.05% to 0.3% C, 0.5% to 2.5% Si, 1.5% to 3.5% Mn, 0.001% to 0.05% P, 0.0001% to 0.01% S, 0.001% to 0.1% Al, 0.0005% to 0.01% N, and 1.5% or less Cr (including 0%) on a mass basis, the remainder being Fe and unavoidable impurities; satisfies Inequalities (1) and (2) below; and contains a ferritic phase and a martensitic phase, the area fraction of the martensitic phase in a microstructure being 30% or more, the quotient (the area occupied by the martensitic phase)/(the area occupied by the ferritic phase) being greater than 0.45 to less than 1.5, the average grain size of the martensitic phase being 2 μm or more:

[C]^{1/2}×([Mn]+0.6×[Cr])≧1−0.12×[Si] (1)

and

550−350×C*−40×[Mn]−20×[Cr]+30×[Al]≧340 (2)

where C*=[C]/(1.3×[C]+0.4×[Mn]+0.45×[Cr]−0.75), [M] represents the content (% by mass) of an element M, and [Cr]=0 when the content of Cr is 0%.

In the high-strength cold-rolled steel sheet, the quotient (the hardness of the martensitic phase)/(the hardness of the ferritic phase) is preferably 2.5 or less. The area fraction of a martensitic phase having a grain size of 1 μm or less in the martensitic phase is preferably 30% or less.

In the high-strength cold-rolled steel sheet, the content of Cr is preferably 0.01% to 1.5% on a mass basis. The high-strength cold-rolled steel sheet preferably further contains at least one of 0.0005% to 0.1% Ti and 0.0003% to 0.003% B on a mass basis. The high-strength cold-rolled steel sheet preferably further contains 0.0005% to 0.05% Nb on a mass basis. The high-strength cold-rolled steel sheet preferably further contains at least one selected from the group consisting of 0.01% to 1.0% Mo, 0.01% to 2.0% Ni, and 0.01% to 2.0% Cu on a mass basis. When the high-strength cold-rolled steel sheet contains Mo, Ni, and/or Cu, the high-strength cold-rolled steel sheet needs to satisfy Inequality (3) below instead of Inequality (2):

550−350×C*−40×[Mn]−20×[Cr]+30×[Al]−10×[Mo]−17×[Ni]−10×[Cu]≧340 (3)

where C*=[C]/(1.3×[C]+0.4×[Mn]+0.45×[Cr]−0.75), [M] represents the content (% by mass) of an element M, and [Cr]=0 when the content of Cr is 0%.

The high-strength cold-rolled steel sheet can be manufactured by, for example, a method including annealing a steel sheet containing the above components in such a manner that the steel sheet is heated to a temperature not lower than the Ac₁ transformation point thereof at an average heating rate of 5° C./s or more, is further heated to a temperature not lower than (Ac₃ transformation point−T1×T2)° C. at an average heating rate of less than 5° C./s, is soaked at a temperature not higher than the Ac₃ transformation point thereof for 30 s to 500 s, and is then cooled to a cooling stop temperature of 600° C. or lower at an average cooling rate of 3° C./s to 30° C./s.

T1=160+19×[Si]−42×[Cr], T2=0.26+0.03×[Si]+0.07×[Cr], [M] represents the content (% by mass) of an element M, and [Cr]=0 when the content of Cr is 0%.

In the method for manufacturing the high-strength cold-rolled steel sheet, the annealed steel sheet may be heat-treated at a temperature of 300° C. to 500° C. for 20 s to 150 s before the annealed steel sheet is cooled to room temperature.

We also provide a high-strength galvanized steel sheet having excellent formability, containing 0.05% to 0.3% C, 0.5% to 2.5% Si, 1.5% to 3.5% Mn, 0.001% to 0.05% P, 0.0001% to 0.01% S, 0.001% to 0.1% Al, 0.0005% to 0.01% N, and 1.5% or less Cr (including 0%) on a mass basis, the remainder being Fe and unavoidable impurities; satisfying Inequalities (1) and (2) described above; and containing a ferritic phase and a martensitic phase, the area fraction of the martensitic phase in a microstructure being 30% or more, the quotient (the area occupied by the martensitic phase)/(the area occupied by the ferritic phase) being greater than 0.45 to less than 1.5, the average grain size of the martensitic phase being 2 μm or more.

In the high-strength galvanized steel sheet, the quotient (the hardness of the martensitic phase)/(the hardness of the ferritic phase) is preferably 2.5 or less. The area fraction of a martensitic phase having a grain size of 1 μm or less in the martensitic phase is preferably 30% or less.

In the high-strength galvanized steel sheet, the content of Cr is preferably 0.01% to 1.5% on a mass basis. The high-strength galvanized steel sheet preferably further contains at least one of 0.0005% to 0.1% Ti and 0.0003% to 0.003% B on a mass basis. The high-strength galvanized steel sheet preferably further contains 0.0005% to 0.05% Nb on a mass basis. The high-strength galvanized steel sheet preferably further contains at least one selected from the group consisting of 0.01% to 1.0% Mo, 0.01% to 2.0% Ni, and 0.01% to 2.0% Cu on a mass basis. When the high-strength galvanized steel sheet contains Mo, Ni, and/or Cu, the high-strength galvanized steel sheet needs to satisfy Inequality (3) instead of Inequality (2).

In the high-strength galvanized steel sheet, a zinc coating may be an alloyed zinc coating.

The high-strength galvanized steel sheet can be manufactured by a method including annealing a steel sheet containing the above components such that the steel sheet is heated to a temperature not lower than the Ac₁ transformation point thereof at an average heating rate of 5° C./s or more, is further heated to a temperature not lower than (Ac₃ transformation point−T1×T2)° C. at an average heating rate of less than 5° C./s, is soaked at a temperature not higher than the Ac₃ transformation point thereof for 30 s to 500 s, and is then cooled to a cooling stop temperature of 600° C. or lower at an average cooling rate of 3° C./s to 30° C./s and also including galvanizing the steel sheet by hot dipping. The definitions of T1 and T2 are as described above.

In the method for manufacturing the high-strength galvanized steel sheet, the annealed steel sheet may be heat-treated at a temperature of 300° C. to 500° C. for 20 s to 150 s before the annealed steel sheet is galvanized. A zinc coating may be alloyed at a temperature of 450° C. to 600° C. subsequently to hot dip galvanizing.

Hence, the following steel sheets can be manufactured: a high-strength cold-rolled steel sheet and high-strength galvanized steel sheet having a TS of 1180 MPa or more, excellent stretch flangeability, and excellent bendability. The application of the high-strength cold-rolled steel sheet and/or high-strength galvanized steel sheet to structural parts of automobiles allows the safety of occupants to be ensured and also allows fuel efficiency to be significantly improved due to automotive lightening.

### BRIEF DESCRIPTION OF DRAWINGS

FIG. 1 is a graph showing the relationship between [C]^{1/2}×([Mn]+0.6×[Cr])−(1−0.12×[Si]), TS×El, and λ.

### DETAILED DESCRIPTION

Details will now be described. The unit “%” used to express the content of each component or element refers to “mass percent” unless otherwise specified.

### (1) Composition

### C: 0.05% to 0.3%

C is an element which is important in hardening steel, which has high ability for solid solution hardening and is essential to adjust the area fraction and hardness of a martensitic phase in the case of making use of strengthening due to the martensitic phase. When the content of C is less than 0.05%, it is difficult to achieve a desired amount of the martensitic phase and sufficient strength cannot be achieved because the martensitic phase is not hardened. However, when the content of C is greater than 0.3%, weldability is deteriorated and formability, particularly stretch flangeability or bendability, is reduced because the martensitic phase is excessively hardened. Thus, the content of C is 0.05% to 0.3%.

### Si: 0.5% to 2.5%

Si is an element which is extremely important, promotes transformation of ferrite during annealing, transfers solute C from a ferritic phase to an austenitic phase to clean the ferritic phase, increases ductility, and produces a martensitic phase even in the case of performing annealing with a continuous annealing line or continuous galvanizing line unsuitable for rapid cooling for the purpose of stabilizing the austenitic phase to readily produce a multi-phase microstructure. In particular, in a cooling step, the transfer of solute C to the austenitic phase stabilizes the austenitic phase, prevents the production of a pearlitic phase and a bainitic phase, and promotes the production of the martensitic phase. Si dissolved in the ferritic phase promotes work hardening to increase ductility and improves the strain transmissivity of zones where strain is concentrated to enhance stretch flangeability and bendability. Furthermore, Si hardens the ferritic phase to reduce the difference in hardness between the ferritic phase and the martensitic phase, suppresses the formation of cracks at the interface therebetween to improve local deformability, and contributes to the enhancement of stretch flangeability and bendability. To achieve such effects, the content of Si needs to be 0.5% or more. However, when the content of Si is greater than 2.5%, production stability is inhibited because of an extreme increase in transformation point and unusual structures are grown to cause a reduction in formability. Thus, the content of Si is 0.5% to 2.5%.

### Mn: 1.5% to 3.5%

Mn is effective in preventing the thermal embrittlement of steel, effective in ensuring the strength thereof, and enhances the hardenability thereof to readily produce a multi-phase microstructure. Furthermore, Mn increases the percentage of a secondary phase during annealing, reduces the content of C in an untransformed austenitic phase, allows the self tempering of a martensitic phase produced in a cooling step during annealing or a cooling step subsequent to hot dip galvanizing to readily occur, reduces the hardness of the martensitic phase in the final microstructure, and prevents local deformation to significantly contribute to the enhancement of stretch flangeability and bendability. To achieve such effects, the content of Mn needs to be 1.5% or more. However, when the content of Mn is greater than 3.5%, segregation layers are significantly produced and therefore formability is deteriorated. Thus, the content of

### Mn is 1.5% to 3.5%.

### P: 0.001% to 0.05%

P is an element which can be used depending on desired strength and is effective in producing a multi-phase microstructure for the purpose of promoting ferrite transformation. To achieve such effects, the content of P needs to be 0.001% or more. However, when the content of P is greater than 0.05%, weldability is deteriorated and in the case of alloying a zinc coating, the quality of the zinc coating is deteriorated because the alloying rate thereof is reduced. Thus, the content of P is 0.001% to 0.05%.

### S: 0.0001% to 0.01%

S segregates to grain boundaries to brittle steel during hot working and is present in the form of sulfides to reduce local deformability. Thus, the content of S needs to be preferably 0.01% or less, more preferably 0.003% or less, and further more preferably 0.001% or less. However, the content of S needs to be 0.0001% or more because of technical constraints on production. Thus, the content of S is preferably 0.0001% to 0.01%, more preferably 0.0001% to 0.003%, and further more preferably 0.0001% to 0.001%.

### Al: 0.001% to 0.1%

Ai is an element which is effective in producing a ferritic phase to increase the balance between strength and ductility. To achieve such an effect, the content of Al needs to be 0.001% or more. However, when the content of Al is greater than 0.1%, surface quality is deteriorated. Thus, the content of Al is 0.001% to 0.1%.

### N: 0.0005% to 0.01%

N is an element which deteriorates the aging resistance of steel. In particular, when the content of N is greater than 0.01%, the deterioration of aging resistance is significant. The content thereof is preferably small. However, the content of N needs to be 0.0005% or more because of technical constraints on production. Thus, the content of N is 0.0005% to 0.01%.

### Cr: 1.5% or Less (Including 0%)

When the content of Cr is greater than 1.5%, ductility is reduced because the percentage of a secondary phase is extremely large or Cr carbides are excessively produced. Thus, the content of Cr is 1.5% or less. Cr reduces the content of C in an untransformed austenitic phase, allows the self tempering of a martensitic phase produced in a cooling step during annealing or a cooling step subsequent to hot dip galvanizing to readily occur, reduces the hardness of the martensitic phase in the final microstructure, prevents local deformation to enhance stretch flangeability and bendability, forms a solid solution in a carbide to facilitate the production of the carbide, is self-tempered in a short time, facilitates the transformation from the austenitic phase to the martensitic phase, and can produce a sufficient fraction of the martensitic phase. Hence, the content thereof is preferably 0.01% or more.

[C]^{1/2}×([Mn]+0.6×[Cr])≧1−0.12×[Si] Inequality (1)

To achieve a TS of 1180 MPa or more, an appropriate amount of an alloy element effective in structure hardening and solid solution hardening needs to be used. To achieve sufficient strength and excellent formability, the area fraction of each of a ferritic phase and a martensitic phase needs to be appropriately controlled and the morphology of each phase needs to be adjusted. Therefore, the content of each of C, Mn, Cr, and Si needs to satisfy Inequality (1).

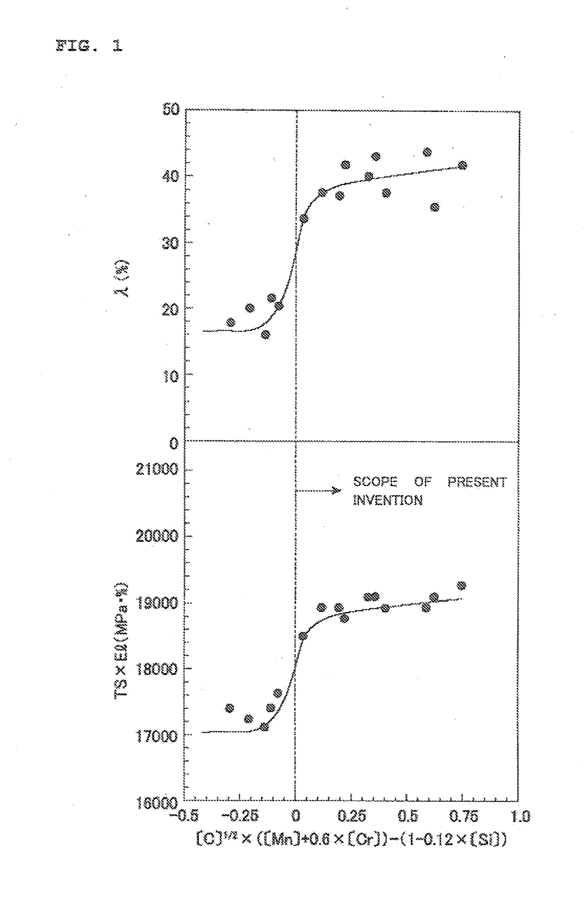

FIG. 1 shows the relationship between [C]^{1/2}×([Mn]+0.6×[Cr])−(1−0.12×[Si]), the strength-ductility balance TS×El (El: elongation), and the hole expansion ratio λ below. The relationship was obtained such that galvanized steel sheets prepared by the following procedure were measured for TS×El and λ and correlations between these characteristics and the steel component formula [C]^{1/2}×([Mn]+0.6×[Cr])−(1−0.12×[Si]): 1.6 mm thick cold-rolled steel sheets having various C, Mn, Cr, and Si contents were heated to 750° C. at an average rate of 10° C./s; further heated to a temperature of (Ac₃ transformation point—10)° C. at an average rate of 1° C./s; soaked at that temperature for 120 s; cooled to 525° C. at an average rate of 15° C./s; dipped in a 475° C. zinc plating bath containing 0.13% Al for 3 s; and then alloyed at 525° C. This FIGURE illustrates that TS×El and λ are significantly increased under conditions satisfying Inequality (1). The reason why formability is significantly increased as described above is probably that a martensitic phase is appropriately self-tempered under the conditions satisfying Inequality (1) and therefore local deformability is increased.

550−350×C*−40×[Mn]−20×[Cr]+30×[Al]≧340, where C*=[C]/(1.3×[C]+0.4×[Mn]+0.45×[Cr]−0.75) Inequality (2)

To obtain a steel sheet having a TS of 1180 MPa or more, excellent stretch flangeability, and excellent bendability, it is effective that the area fraction of each of a ferritic phase and a martensitic phase is appropriately controlled and the hardness of the martensitic phase is reduced. To reduce the hardness of the martensitic phase in a cooling step during annealing or in a cooling step subsequent to hot dip galvanizing, the content of C in the untransformed austenitic phase needs to be reduced such that the Ms point is increased and self-tempering occurs. When the Ms point is increased to a high temperature sufficient to allow the diffusion of C, martensite transformation and self-tempering occur at the same time. C* in Inequality (2) is given by an empirical formula determined from various experiment results and substantially represents the content of C in the untransformed austenitic phase in the cooling step during annealing. When the value of the left-hand side of Inequality (2) is 340 or more as determined by assigning C* to the term C in a formula representing the Ms point, the self-tempering of the martensitic phase is likely to occur in the cooling step during annealing or in the cooling step subsequent to hot dip galvanizing. Hence, the hardness of the martensitic phase is reduced, local deformation is suppressed, and stretch flangeability and bendability are enhanced.

The remainder is Fe and unavoidable impurities. The following element is preferably contained because of reasons below: at least one of 0.0005% to 0.1% Ti and 0.0003% to 0.003% B; at least one selected from the group consisting of 0.0005% to 0.05% Nb, 0.01% to 1.0% Mo, 0.01% to 2.0% Ni, and 0.01% to 2.0% Cu; or 0.001% to 0.005% Ca. When Mo, Ni, and/or Cu is contained, Inequality (3) needs to be satisfied instead of Inequality (2) because of the same reason as that for Inequality (2).

### Ti and B: 0.0005% to 0.1% and 0.0003% to 0.003%, Respectively

Ti forms precipitates together with C, S, and N to effectively contribute to the enhancement of strength and toughness. When Ti and B are both contained, the precipitation of BN is suppressed because Ti precipitates N in the form of TiN. Hence, effects due to B are effectively expressed as described below. To achieve such effects, the content of Ti needs to be 0.0005% or more. However, when the content of Ti is greater than 0.1%, precipitation hardening proceeds excessively to cause a reduction in ductility. Thus, the content of Ti is 0.0005% to 0.1%.

The presence of B together with Cr increases the effects of Cr, that is, the effect of increasing the percentage of the secondary phase during annealing, the effect of reducing the stability of the martensitic phase, and the effect of facilitating martensite transformation and subsequent self-tempering in a cooling step during annealing or a cooling step subsequent to hot dip galvanizing. To achieve these effects, the content of B needs to be 0.0003%. However, when the content of B is greater than 0.003%, a reduction in ductility is caused. Thus, the content of B is 0.0003% to 0.003%.

### Nb: 0.0005% to 0.05%

Nb hardens steel by precipitation hardening and therefore can be used depending on desired strength. To achieve such an effect, the content of Nb needs to be 0.0005% or more. When the content of Nb is greater than 0.05%, precipitation hardening proceeds excessively to cause a reduction in ductility. Thus, the content of Nb is 0.0005% to 0.05%.

### Mo, Ni, and Cu: 0.01% to 1.0%, 0.01% to 2.0%, and 0.01% to 2.0%, Respectively

Mo, Ni, and Cu function as precipitation-hardening elements and stabilize an austenitic phase in a cooling step during annealing to readily produce a multi-phase microstructure. To achieve such an effect, the content of each of Mo, Ni, and Cu needs to be 0.01% or more. However, when the content of Mo, Ni, or Cu is greater than 1.0%, 2.0%, or 2.0%, respectively, wettability, formability, and/or spot weldability is deteriorated. Thus, the content of Mo is 0.01% to 1.0%, the content of Ni is 0.01% to 2.0%, and the content of Cu 0.01% to 2.0%.

### Ca: 0.001% to 0.005%

Ca has precipitates S in the form of CaS to prevent the production of MnS, which causes the creation and propagation of cracks and therefore has the effect of enhancing stretch flangeability and bendability. To achieve the effect, the content of Ca needs to be 0.001% or more. However, when the content of Ca is greater than 0.005%, the effect is saturated. Thus, the content of Ca is 0.001% to 0.005%.

### (2) Microstructure

### Area Fraction of Martensitic Phase: 30% or More

In view of the strength-ductility balance, a microstructure contains a ferritic phase and a martensitic phase. To achieve a strength of 1180 MPa or more, the area fraction of the martensitic phase in the microstructure needs to be 30% or more. The martensitic phase contains one or both of an untempered martensitic phase and a tempered martensitic phase. Tempered martensite preferably occupies 20% of the martensitic phase.

The term “untempered martensitic phase” as used herein is a texture which has the same chemical composition as that of an untransformed austenitic phase and a body-centered cubic structure and in which C is supersaturatedly dissolved in the form of a solid solution and refers to a hard phase having a microstructure such as a lath, a packet, or a block and high dislocation density. The term “tempered martensitic phase” as used herein refers to a ferritic phase in which supersaturated solute C is precipitated from a martensitic phase in the form of carbides, in which the microstructure of a parent phase is maintained, and which has high dislocation density. The tempered martensitic phase need not be distinguished from others depending on thermal history, such as quench annealing or self-tempering, for obtaining the tempered martensitic phase.

Quotient (Area Occupied by Martensitic Phase)/(Area Occupied by Ferritic Phase): Greater than 0.45 to Less than 1.5

When the quotient (the area occupied by the martensitic phase)/(the area occupied by the ferritic phase) is greater than 0.45, local deformability is increased and stretch flangeability and bendability are enhanced. However, when the quotient (the area occupied by the martensitic phase)/(the area occupied by the ferritic phase) is 1.5 or more, the area fraction of a ferritic phase is reduced and ductility is significantly reduced. Thus, the quotient (the area occupied by the martensitic phase)/(the area occupied by the ferritic phase) needs to be greater than 0.45 to less than 1.5.

### Average Grain Size of Martensitic Phase: 2 μm or More

When the grain size of a martensitic phase is small, local cracks are created and therefore local deformability is likely to be reduced. Hence, the average grain size thereof needs to be 2 μm or more. The area fraction of a martensitic phase having a grain size of 1 μm or less in the martensitic phase is preferably 30% or less because of a similar reason.

When the concentration of stress at the interface between the martensitic phase and a ferritic phase is significant, local cracks are created. Hence, the quotient (the hardness of the martensitic phase)/(the hardness of the ferritic phase) is preferably 2.5 or less.

If a retained austenitic phase, a pearlitic phase, or a bainitic phase is contained in addition to the ferritic phase and the martensitic phase, advantages are not reduced.

The area fraction of each of the ferritic and martensitic phases is herein defined as the percentage of the area of each phase in the area of a field of view. The area fraction of each phase and the grain size and average grain size of the martensitic phase are determined with a commercially available image-processing software program (for example, Image-Pro available from Media Cybernetics) such that a widthwise surface of a steel sheet that is parallel to the rolling direction of the steel sheet is polished and is then corroded with 3% nital and ten fields of view thereof are observed with a SEM (scanning electron microscope) at a magnification of 2000 times. That is, the area fraction of each phase is determined such that the ferritic or martensitic phase is identified from a microstructure photograph taken with the SEM and the photograph and binarization is performed for each phase. This allows the area fraction of the martensitic or ferritic phase to be determined. The average grain size of martensite can be determined such that individual equivalent circle diameters are derived for the martensitic phase and are then averaged. The area fraction of a martensitic phase having a grain size of 1 μm or less in the martensitic phase is preferably 30% or less can be determined in such a manner that the martensitic phase having a grain size of 1 μm or less is extracted and is then measured for area.

The quotient (the hardness of the martensitic phase)/(the hardness of the ferritic phase) can be determined such that at least ten grains of each phase are measured for hardness by a nanoindentation technique as disclosed in The Japan Institute of Metals, Materia Japan, Vol. 46, No. 4, 2007, pp. 251-258 and the average hardness of the phase is calculated.

The untempered martensitic phase and the tempered martensitic phase can be identified from surface morphology after nital corrosion. That is, the untempered martensitic phase has a smooth surface and the tempered martensitic phase has structures (irregularities), caused by corrosion, observed in grains thereof. The untempered martensitic phase and the tempered martensitic phase can be identified by this method for each grain. The area fraction of each phase and the area fraction of the tempered martensitic phase in the martensitic phase can be determined by a technique similar to the above method.

### (3) Manufacturing Conditions

A high-strength cold-rolled steel sheet can be manufactured by the following method: for example, a steel sheet having the above composition is annealed such that the steel sheet is heated to a temperature not lower than the Ac₁ transformation point thereof at an average heating rate of 5° C./s or more, is further heated to a temperature not lower than (Ac₃ transformation point−T1×T2)° C. at an average heating rate of less than 5° C./s, is soaked at a temperature not higher than the Ac₃ transformation point thereof for 30 s to 500 s, and is then cooled to a cooling stop temperature of 600° C. or lower at an average cooling rate of 3° C./s to 30° C./s as described above.

A high-strength galvanized steel sheet can be manufactured by the following method: for example, a steel sheet having the above composition is annealed in such a manner that the steel sheet is heated to a temperature not lower than the Ac₁ transformation point thereof at an average heating rate of 5° C./s or more, further heated to a temperature not lower than (Ac₃ transformation point−T1×T2)° C. at an average heating rate of less than 5° C./s, soaked at a temperature not higher than the Ac₃ transformation point thereof for 30 s to 500 s, and then cooled to a cooling stop temperature of 600° C. or lower at an average cooling rate of 3° C./s to 30° C./s as described above and the annealed steel sheet is galvanized by hot dipping.

The method for manufacturing the high-strength cold-rolled steel sheet and the method for manufacturing the high-strength galvanized steel sheet have the same conditions for performing heating, soaking, and cooling during annealing. The only difference between these methods is whether plating is performed or not after annealing is performed.

### Heating Condition 1 During Annealing

Heating to a Temperature not Lower than the Ac₁ Transformation Point at an Average Heating Rate of 5° C./s or More

The production of a recovered or recrystallized ferritic phase can be suppressed and austenite transformation can be carried out by heating the steel sheet to a temperature not lower than the Ac₁ transformation point at an average heating rate of 5° C./s or more. Therefore, the percentage of an austenitic phase is increased, a predetermined area fraction of a martensitic phase can be finally obtained, and the ferritic phase and the martensitic phase can be uniformly dispersed. Hence, necessary strength can be ensured and stretch flangeability and bendability can be enhanced. When the average rate of heating the steel sheet to the Ac₁ transformation point is less than 5° C./s, recovery or recrystallization proceeds excessively and therefore it is difficult to obtain the martensitic phase such that the martensitic phase has an area fraction of 30% or more and the ratio of the area of the martensitic phase to the area of the ferritic phase is greater than 0.45.

### Heating Condition 2 During Annealing

Heating to a Temperature not Lower than (Ac₃ Transformation Point−T1×T2)° C. at an Average Heating Rate of Less than 5° C./s

To secure the predetermined area fraction and grain size of the martensitic phase, the austenitic phase needs to be grown to an appropriate size in the course from heating to soaking. However, when the average heating rate is large at high temperatures, the austenitic phase is finely dispersed and therefore individual austenitic phases cannot be grown. Hence, the austenitic phases remain fine even if the martensitic phase has a predetermined area fraction in a final microstructure. In particular, when the average heating rate is 5° C./s at high temperatures not lower than (Ac₃ transformation point−T1×T2)° C., the martensitic phase has an average grain size of below 2 μm and the area fraction of a martensitic phase with a size of 1 μm or less is increased. T1 and T2 are defined as described below. T1 and T2 correlate to the content of Si and that of Cr. T1 and T2 are given by empirical formulas determined from experimental results. T1 represents a temperature range where the ferritic phase and the austenitic phase coexist. T2 represents the ratio of a temperature range sufficient to cause self-tempering in a series of subsequent steps to the temperature range where the two phases coexist.

Soaking Conditions During Annealing: Soaking at a Temperature not Higher than the Ac₃ Transformation Point for 30 s to 500 s

The increase of the percentage of the austenitic phase during soaking reduces the content of C in the austenitic phase to increase the Ms point, provides a self-tempering effect in a cooling step during annealing or a cooling step subsequent to hot dip galvanizing, and allows sufficient strength to be accomplished even if the hardness of the martensitic phase is reduced by tempering. Hence, a TS of 1180 MPa or more, excellent stretch flangeability, and excellent bendability can be achieved. However, when the soaking temperature is higher than the Ac₃ transformation point, the production of the ferritic phase is insufficient and therefore ductility is reduced. When the soaking time is less than 30 s, the ferritic phase produced during heating is not sufficiently transformed into the austenitic phase and therefore a necessary amount of the austenitic phase cannot be obtained. However, when the soaking time is greater than 500 s, an effect is saturated and manufacturing efficiency is inhibited.

The high-strength cold-rolled steel sheet and the high-strength galvanized steel sheet are different in condition from each other after soaking and therefore are separately described below.

### (3-1) Case of High-Strength Cold-Rolled Steel Sheet

### Cooling Conditions During Annealing: Cooling to a Cooling Stop Temperature of 600° C. or Lower From the Soaking Temperature at an Average Cooling Rate of 3° C./s to 30° C./s

After the steel sheet is soaked, the steel sheet needs to be cooled to a cooling stop temperature of 600° C. or lower at an average cooling rate of 3° C./s to 30° C./s. This is because when the average cooling rate is less than 3° C./s, ferrite transformation proceeds during cooling to cause C to be concentrated in an untransformed austenitic phase so that no self-tempering effect is achieved and stretch flangeability and bendability are reduced, and when the average cooling rate is greater than 30° C./s, the effect of suppressing ferrite transformation is saturated and it is difficult for common production facilities to accomplish such a rate. The reason why the cooling stop temperature is set to 600° C. or lower is that when the cooling stop temperature is higher than 600° C., the ferritic phase is significantly produced during cooling it is difficult to adjust the area fraction of the martensitic phase to a predetermined value and it is difficult to adjust the ratio of the area of the martensitic phase to the area of the ferritic phase to a predetermined value.

### (3-2) Case of High-Strength Galvanized Steel Sheet

Cooling Conditions During Annealing: Cooling to a Cooling Stop Temperature of 600° C. or Lower from the Soaking Temperature at an Average Cooling Rate of 3° C./s to 30° C./s

After the steel sheet is soaked, the steel sheet needs to be cooled to a cooling stop temperature of 600° C. or lower at an average cooling rate of 3° C./s to 30° C./s. This is because when the average cooling rate is less than 3° C./s, ferrite transformation proceeds during cooling to cause C to be concentrated in an untransformed austenitic phase so that no self-tempering effect is achieved and stretch flangeability and bendability are reduced, and when the average cooling rate is greater than 30° C./s, the effect of suppressing ferrite transformation is saturated and it is difficult for common production facilities to accomplish such a rate. The reason why the cooling stop temperature is set to 600° C. or lower is that when the cooling stop temperature is higher than 600° C., the ferritic phase is significantly produced during cooling it is difficult to adjust the area fraction of the martensitic phase to a predetermined value and it is difficult to adjust the ratio of the area of the martensitic phase to the area of the ferritic phase to a predetermined value.

After annealing is performed, hot dip galvanizing is performed under usual conditions. Heat treatment is preferably performed prior to galvanizing as described below. The method for manufacturing the high-strength cold-rolled steel sheet may include such heat treatment which is prior to annealing and which is subsequent to cooling to room temperature.

### Conditions of Heat Treatment Subsequent to Annealing: a Temperature of 300° C. to 500° C. for 20 s to 150 s

Heat treatment is performed at a temperature of 300° C. to 500° C. for 20 s to 150 s subsequently to annealing, whereby the hardness of the martensitic phase can be effectively reduced by self-tempering and stretch flangeability and bendability can be enhanced. When the heat treatment temperature is lower than 300° C. or the heat treatment time is less than 20 s, such advantages are small. When the heat treatment temperature is higher than 500° C. or the heat treatment time is greater than 150 s, the reduction in hardness of the martensitic phase is significant and a TS of 1180 MPa or more cannot be achieved.

In the case of manufacturing the galvanized steel sheet, a zinc coating may be alloyed at a temperature of 450° C. to 600° C. independently of whether the heat treatment is performed subsequently to annealing. Alloying the zinc coating at a temperature of 450° C. to 600° C. allows the concentration of Fe in the coating to be 8% to 12% and enhances the adhesion and corrosion resistance of the coating after painting. When the temperature is lower than 450° C., alloying does not sufficiently proceed and a reduction in galvanic action and/or a reduction in slidability is caused. When the temperature is higher than 600° C., alloying excessively proceeds and powdering properties are reduced. Furthermore, a large amount of a pearlitic phase and/or a bainitic phase is produced and therefore an increase in strength and/or an increase in stretch flangeability cannot be achieved.

Other manufacturing conditions are not particularly limited and are preferably as described below.

The unannealed steel sheet used to manufacture the high-strength cold-rolled steel sheet or high-strength galvanized steel sheet is manufactured such that a slab having the above composition is hot-rolled and is then cold-rolled to a desired thickness. In view of manufacturing efficiency, the high-strength cold-rolled steel sheet is preferably manufactured with a continuous annealing line and the high-strength galvanized steel sheet is preferably manufactured with a continuous galvanizing line capable of performing a series of treatments such as galvanizing pretreatment, galvanizing, and alloying the zinc coating.

The slab is preferably manufactured by a continuous casting process for the purpose of preventing macro-segregation and may be manufactured by an ingot making process or a thin slab-casting process. The slab is reheated in a step of hot-rolling the slab. To prevent an increase in rolling load, the reheating temperature thereof is preferably 1150° C. or higher. To prevent an increase in scale loss and an increase in fuel unit consumption, the upper limit of the reheating temperature thereof is preferably 1300° C.

Hot rolling includes rough rolling and finish rolling. To prevent a reduction in formability after cold rolling and annealing, finish rolling is preferably performed at a finishing temperature not lower than the Ac₃ transformation point. To prevent the unevenness of a microstructure due to the coarsening of grains or to prevent scale defects, the finishing temperature is preferably 950° C. or lower.

The hot-rolled steel sheet is preferably coiled at a coiling temperature of 500° C. to 650° C. for the purpose of preventing scale defects or ensuring good shape stability.

After the coiled steel sheet is descaled by pickling or the like, the coiled steel sheet is preferably cold-rolled at a reduction of 40% or more for the purpose of efficiently producing a polygonal ferritic phase.

A galvanizing bath containing 0.10% to 0.20% Al is preferably used for hot dip galvanizing. After galvanizing is performed, wiping may be performed for the purpose of adjusting the area weight of the coating.

### Example 1

Steel Nos. A to P having compositions shown in Table 1 were produced in a steel converter and were then converted into slabs by a continuous casting process. After the slabs were heated to 1200° C., the slabs were hot-rolled at a finishing temperature of 850° C. to 920° C. The hot-rolled steel sheets were coiled at a coiling temperature of 600° C. After being pickled, the hot-rolled steel sheets were cold-rolled to thicknesses shown in Table 2 at a reduction of 50% and were then each annealed with a continuous annealing line under annealing conditions shown in Table 2, whereby Cold-rolled Steel Sheet Nos. 1 to 24 were prepared. The obtained cold-rolled steel sheets were measured for the area fraction of a ferritic phase, the area fraction of a martensitic phase including a tempered martensitic phase and an untempered martensitic phase, the ratio of the area of the martensitic phase to the area of the ferritic phase, the average grain size of the martensitic phase, the area fraction of the tempered martensitic phase in the martensitic phase, the area fraction of a tempered martensitic phase having a grain size of 1 μm or less in the martensitic phase, and the ratio of the hardness of the martensitic phase to that of the ferritic phase by the above methods. JIS #5 tensile specimens perpendicular to the rolling direction were taken and were then measured for TS and elongation El such that the specimens were subjected to a tensile test at a cross-head speed of 20 mm/min in accordance with JIS Z 2241. Furthermore, 100 mm square specimens were taken and were then measured for average hole expansion ratio λ (%) such that these specimens were subjected to a hole-expanding test in accordance with JFS T 1001 (The Japan Iron and Steel Federation standard) three times, whereby the specimens were evaluated for stretch flangeability. Furthermore, 30 mm wide, 120 mm long strip specimens perpendicular to the rolling direction were taken, end portions thereof were smoothed to have a surface roughness Ry of 1.6 to 6.3 S, the strip specimens were subjected to a bending test at a bending angle of 90° by a V-block method, whereby the critical bend radius defined as the minimum bend radius causing no cracking or necking was determined.

Results are shown in Table 3. Cold-rolled steel sheets that are our examples have excellent stretch flangeability and bendability because these cold-rolled steel sheets have a TS of 1180 MPa or more and a hole expansion ratio λ of 30% or more and the ratio of the critical bend radius to the thickness of each cold-rolled steel sheet is less than 2.0. Furthermore, these cold-rolled steel sheets have a good balance between strength and ductility, excellent formability, and high strength because TS×El≧18000 MPa·%.

TABLE 1

| | | | | | | | | | | | | | | | | | | Ac₃ |
|---|---|---|---|---|---|---|---|---|---|---|---|---|---|---|---|---|---|---|
| | | | | | | | | | | | | | | | | Ac₁ | Ac₃ | trans- |
| | | | | | | | | | | Left- | Right- | | Left- | | | trans- | trans- | for- |
| | | | | | | | | | | hand | hand | | hand | | | for- | for- | mation |
| | | | | | | | | | | side of | side of | | side of | | | ma- | ma- | point - |
| | | | | | | | | | | Ine- | Ine- | | Ine- | | | tion | tion | T1 × |
| Steel | Components (% by mass) | | | | | | | | | quality | quality | | quality | | | point | point | T2 |
| No. | C | Si | Mn | P | S | Al | N | Cr | Others | (1) | (1) | C* | (2) | T1 | T2 | (° C.) | (° C.) | (° C.) |
| A | 0.141 | 1.51 | 2.62 | 0.012 | 0.002 | 0.010 | 0.0048 | 0.01 | — | 0.99 | 0.82 | 0.29 | 344 | 188 | 0.31 | 662 | 835 | 777 |
| B | 0.103 | 1.65 | 2.36 | 0.010 | 0.001 | 0.018 | 0.0039 | 0.36 | Ti: 0.019, | 0.83 | 0.80 | 0.21 | 375 | 176 | 0.33 | 674 | 842 | 783 |
| | | | | | | | | | B: 0.0011 | | | | | | | | | |
| C | 0.134 | 1.45 | 2.44 | 0.010 | 0.002 | 0.022 | 0.0036 | 1.00 | — | 1.11 | 0.83 | 0.16 | 378 | 140 | 0.37 | 685 | 836 | 782 |
| D | 0.232 | 1.27 | 1.97 | 0.008 | 0.002 | 0.014 | 0.0020 | 0.90 | Nb: 0.026 | 1.21 | 0.85 | 0.31 | 345 | 146 | 0.36 | 689 | 787 | 734 |
| E | 0.189 | 2.07 | 2.41 | 0.013 | 0.001 | 0.024 | 0.0038 | 0.34 | Ti: 0.021, | 1.14 | 0.75 | 0.31 | 332 | 185 | 0.35 | 665 | 842 | 778 |
| | | | | | | | | | B: 0.0009 | | | | | | | | | |
| | | | | | | | | | Ni: 0.33, | | | | | | | | | |
| | | | | | | | | | Cu: 0.20 | | | | | | | | | |
| F | 0.103 | 1.17 | 3.02 | 0.012 | 0.001 | 0.016 | 0.0040 | 0.52 | Ti: 0.023, | 1.07 | 0.86 | 0.12 | 376 | 160 | 0.33 | 662 | 831 | 778 |
| | | | | | | | | | B: 0.0010 | | | | | | | | | |
| | | | | | | | | | Ca: 0.0019 | | | | | | | | | |
| G | 0.197 | 1.45 | 2.16 | 0.015 | 0.002 | 0.020 | 0.0031 | 0.20 | — | 1.01 | 0.83 | 0.43 | 310 | 179 | 0.32 | 667 | 815 | 758 |
| H | 0.061 | 0.80 | 3.32 | 0.023 | 0.001 | 0.021 | 0.0031 | 0.01 | Ti: 0.055, | 0.82 | 0.90 | 0.09 | 385 | 175 | 0.28 | 657 | 837 | 787 |
| | | | | | | | | | B: 0.0028 | | | | | | | | | |
| | | | | | | | | | Nb: 0.078 | | | | | | | | | |
| I | 0.416 | 1.19 | 1.55 | 0.025 | 0.002 | 0.024 | 0.0040 | 0.01 | — | 1.00 | 0.86 | 1.00 | 138 | 182 | 0.30 | 659 | 710 | 656 |
| J | 0.117 | 0.03 | 2.56 | 0.016 | 0.002 | 0.017 | 0.0031 | 0.01 | Ti: 0.039, | 0.88 | 1.00 | 0.27 | 351 | 160 | 0.26 | 649 | 782 | 740 |
| | | | | | | | | | B: 0.0012 | | | | | | | | | |
| | | | | | | | | | Nb: 0.042, | | | | | | | | | |
| | | | | | | | | | Mo: 0.19 | | | | | | | | | |
| K | 0.232 | 1.26 | 1.43 | 0.018 | 0.002 | 0.017 | 0.0034 | 0.30 | Ni: 0.22 | 0.78 | 0.85 | 0.90 | 170 | 171 | 0.32 | 670 | 795 | 740 |
| L | 0.161 | 1.51 | 2.35 | 0.002 | 0.002 | 0.015 | 0.0048 | 2.29 | — | 1.49 | 0.82 | 0.11 | 371 | 93 | 0.47 | 718 | 821 | 777 |
| M | 0.143 | 1.58 | 3.73 | 0.023 | 0.001 | 0.021 | 0.0030 | 0.01 | — | 1.41 | 0.81 | 0.15 | 348 | 190 | 0.31 | 648 | 818 | 760 |
| N | 0.113 | 1.16 | 2.68 | 0.029 | 0.002 | 0.031 | 0.0028 | 0.00 | — | 0.90 | 0.86 | 0.24 | 359 | 182 | 0.29 | 652 | 832 | 778 |
| O | 0.092 | 1.41 | 2.85 | 0.018 | 0.002 | 0.018 | 0.0026 | 0.00 | Ti: 0.019, | 0.86 | 0.83 | 0.18 | 373 | 187 | 0.30 | 663 | 856 | 800 |
| | | | | | | | | | B: 0.0012 | | | | | | | | | |
| | | | | | | | | | Nb: 0.031 | | | | | | | | | |
| P | 0.112 | 1.62 | 2.45 | 0.021 | 0.001 | 0.022 | 0.0032 | 0.00 | Ni: 0.15, | 0.82 | 0.81 | 0.30 | 348 | 191 | 0.31 | 663 | 861 | 802 |
| | | | | | | | | | Mo: 0.11 | | | | | | | | | |

TABLE 2

| Cold- | | | Annealing conditions | | | | | | | | | |
|---|---|---|---|---|---|---|---|---|---|---|---|---|
| rolled | | | Heating 1 | | Heating 2 | Soaking | | Cooling | | | | |
| steel | | Thick- | Average | Temper- | Average | Temper- | | Average | Stop | Heat treatment | | |
| sheet | Steel | ness | rate | ature | rate | ature | Time | rate | temperature | Temperature | Time | |
| No. | No. | (mm) | (° C./s) | (° C.) | (° C./s) | (° C.) | (s) | (° C./s) | (° C.) | (° C.) | (s) | Remarks |
| 1 | A | 1.2 | 15 | 750 | 2 | 825 | 120 | 15 | 525 | — | — | Example of invention |
| 2 | | 1.2 | 3 | 750 | 2 | 825 | 120 | 15 | 525 | — | — | Comparative example |
| 3 | | 1.2 | 15 | 750 | 2 | 760 | 120 | 15 | 525 | — | — | Comparative example |
| 4 | | 1.2 | 15 | 750 | 2 | 825 | 10 | 15 | 525 | — | — | Comparative example |
| 5 | | 1.2 | 15 | 750 | 2 | 825 | 120 | 2 | 525 | — | — | Comparative example |
| 6 | | 1.2 | 15 | 750 | 2 | 825 | 120 | 15 | 600 | — | — | Comparative example |
| 7 | B | 1.6 | 15 | 750 | 2 | 820 | 90 | 10 | 525 | — | — | Example of invention |
| 8 | | 1.6 | 15 | 650 | 2 | 820 | 90 | 10 | 525 | — | — | Comparative example |
| 9 | | 1.6 | 15 | 750 | 10 | 820 | 90 | 10 | 525 | — | — | Comparative example |
| 10 | | 1.6 | 15 | 750 | 2 | 920 | 90 | 10 | 525 | — | — | Comparative example |
| 11 | C | 1.6 | 10 | 750 | 1 | 825 | 120 | 10 | 525 | 450 | 120 | Example of invention |
| 12 | D | 1.2 | 15 | 750 | 2 | 780 | 150 | 15 | 525 | — | — | Example of invention |
| 13 | E | 1.6 | 10 | 750 | 1 | 825 | 120 | 10 | 525 | — | — | Example of invention |
| 14 | F | 2.3 | 8 | 750 | 1 | 800 | 90 | 6 | 525 | — | — | Example of invention |
| 15 | G | 1.6 | 10 | 750 | 1 | 800 | 120 | 10 | 525 | — | — | Comparative example |
| 16 | H | 1.6 | 10 | 750 | 1 | 800 | 90 | 10 | 525 | — | — | Comparative example |
| 17 | I | 1.2 | 15 | 750 | 2 | 700 | 120 | 15 | 525 | — | — | Comparative example |
| 18 | J | 1.2 | 15 | 750 | 2 | 750 | 90 | 15 | 525 | — | — | Comparative example |
| 19 | K | 1.6 | 10 | 750 | 1 | 780 | 150 | 10 | 525 | — | — | Comparative example |
| 20 | L | 2.3 | 8 | 750 | 1 | 800 | 120 | 6 | 525 | 450 | 120 | Comparative example |
| 21 | M | 1.2 | 15 | 750 | 2 | 800 | 90 | 15 | 525 | — | — | Comparative example |
| 22 | N | 1.2 | 15 | 750 | 2 | 800 | 150 | 15 | 525 | — | — | Example of invention |
| 23 | O | 1.6 | 10 | 750 | 1 | 825 | 150 | 10 | 525 | — | — | Example of invention |
| 24 | P | 1.6 | 10 | 750 | 1 | 825 | 150 | 10 | 525 | 450 | 120 | Example of invention |

TABLE 3

| | Microstructure* | | | | | | | | | | | | |
|---|---|---|---|---|---|---|---|---|---|---|---|---|---|
| | | | | | | Area | | | | | | | |
| | | | | | | fraction | | | | | | | |
| | | | | | | of M | | | | | | | |
| Cold- | | | | Average | Area | having | | | | | | | |
| rolled | Area | Area | Area | grain | fraction | a grain | | | | | | Critical | |
| steel | fraction | fraction | of M/ | size | of | size of | Hardness | Tensile properties | | | | bend | |
| sheet | of F | of M | Area | of M | tempered | 1 μm or | ratio | TS | El | TS × El | λ | radius/ | |
| No. | (%) | (%) | of F | (μm) | M (%) | less (%) | (M/F) | (MPa) | (%) | (MPa · %) | (%) | thickness | Remarks |
| 1 | 60 | 40 | 0.67 | 2.6 | 69 | 26 | 2.43 | 1257 | 16.0 | 20112 | 34 | 0.8 | Example of invention |
| 2 | 68 | 32 | 0.47 | 1.9 | 18 | 18 | 3.15 | 1144 | 14.3 | 16359 | 15 | 2.5 | Comparative example |
| 3 | 73 | 27 | 0.37 | 1.8 | 1 | 38 | 3.60 | 1141 | 16.0 | 18256 | 10 | 2.1 | Comparative example |
| 4 | 50 | 50 | 1.00 | 1.3 | 20 | 45 | 2.98 | 1312 | 11.5 | 15088 | 12 | 2.1 | Comparative example |
| 5 | 75 | 25 | 0.33 | 1.8 | 4 | 42 | 4.30 | 1129 | 17.8 | 20096 | 10 | 2.1 | Comparative example |
| 6 | 62 | 20 | 0.32 | 2.4 | 15 | 9 | 3.39 | 1105 | 15.6 | 17238 | 27 | 2.5 | Comparative example |
| 7 | 66 | 34 | 0.52 | 2.6 | 82 | 9 | 1.98 | 1187 | 16.3 | 19348 | 47 | 0.6 | Example of invention |
| 8 | 72 | 28 | 0.39 | 1.5 | 15 | 47 | 3.43 | 1046 | 18.8 | 19664 | 10 | 2.1 | Comparative example |
| 9 | 59 | 41 | 0.69 | 1.2 | 13 | 46 | 3.28 | 1181 | 12.1 | 14290 | 12 | 2.2 | Comparative example |
| 10 | 21 | 79 | 3.76 | 2.3 | 96 | 18 | 2.05 | 1125 | 12.6 | 14175 | 10 | 2.2 | Comparative example |
| 11 | 55 | 45 | 0.82 | 3.0 | 84 | 27 | 2.24 | 1249 | 17.5 | 21857 | 38 | 0.9 | Example of invention |
| 12 | 60 | 40 | 0.67 | 2.7 | 68 | 22 | 2.30 | 1439 | 14.7 | 21153 | 44 | 0.8 | Example of invention |
| 13 | 58 | 42 | 0.72 | 2.8 | 79 | 21 | 2.54 | 1221 | 18.7 | 22832 | 40 | 0.8 | Example of invention |
| 14 | 43 | 57 | 1.33 | 3.4 | 88 | 23 | 2.32 | 1223 | 15.6 | 19078 | 48 | 0.7 | Example of invention |
| 15 | 54 | 46 | 0.85 | 3.7 | 0 | 16 | 4.46 | 1245 | 14.0 | 17430 | 14 | 2.2 | Comparative example |
| 16 | 34 | 66 | 1.94 | 1.3 | 0 | 40 | 4.33 | 1274 | 12.0 | 15288 | 9 | 2.2 | Comparative example |
| 17 | 56 | 44 | 0.79 | 2.6 | 0 | 18 | 4.44 | 1510 | 10.8 | 16308 | 8 | 2.5 | Comparative example |
| 18 | 35 | 65 | 1.86 | 3.0 | 70 | 15 | 2.12 | 1219 | 10.9 | 13287 | 15 | 2.1 | Comparative example |
| 19 | 75 | 25 | 0.33 | 2.7 | 11 | 9 | 3.75 | 1148 | 15.8 | 18138 | 11 | 2.1 | Comparative example |
| 20 | 24 | 76 | 3.17 | 3.4 | 15 | 29 | 4.18 | 1250 | 11.0 | 13750 | 35 | 0.8 | Comparative example |
| 21 | 39 | 61 | 1.56 | 2.5 | 6 | 13 | 3.55 | 1229 | 13.5 | 16591 | 36 | 0.8 | Comparative example |
| 22 | 62 | 38 | 0.61 | 3.1 | 82 | 18 | 2.31 | 1201 | 16.6 | 19936 | 45 | 0.9 | Example of invention |
| 23 | 55 | 45 | 0.82 | 3.5 | 90 | 9 | 2.12 | 1236 | 15.6 | 19281 | 37 | 0.9 | Example of invention |
| 24 | 58 | 42 | 0.72 | 2.7 | 72 | 22 | 2.27 | 1251 | 15.2 | 19015 | 43 | 1.3 | Example of invention |

*F represents a ferritic phase and M represents a martensitic phase.

### Example 2

Steel Nos. A to P having compositions shown in Table 4 were produced in a steel converter and were then converted into slabs by a continuous casting process. After the slabs were heated to 1200° C., the slabs were hot-rolled at a finishing temperature of 850° C. to 920° C. The hot-rolled steel sheets were coiled at a coiling temperature of 600° C. After being pickled, the hot-rolled steel sheets were cold-rolled to thicknesses shown in Table 5 at a reduction of 50%, were annealed with a continuous galvanizing line under annealing conditions shown in Table 5, were dipped in a 475° C. galvanizing bath containing 0.13% Al for 3 s such that zinc coatings with a mass per unit area of 45 g/m² were formed, and were alloyed at temperatures shown in Table 5, some of the hot-rolled steel sheets being heat-treated at 400° C. for times shown in Table 5 after being annealed, whereby Galvanized Steel Sheet Nos. 1 to 26 were prepared. As shown in Table 5, some of the hot-rolled steel sheets were not alloyed. The obtained galvanized steel sheets were investigated in the same manner as that described in Example 1.

Results are shown in Table 6. Galvanized steel sheets that are our examples have excellent stretch flangeability and bendability because these galvanized steel sheets have a TS of 1180 MPa or more and a hole expansion ratio λ of 30% or more and the ratio of the critical bend radius to the thickness of each galvanized steel sheet is less than 2.0. Furthermore, these galvanized steel sheets have a good balance between strength and ductility, excellent formability, and high strength because TS×El≧18000 MPa·%.

TABLE 4

| | | | | | | | | | | | | | | | | | | Ac₃ |
|---|---|---|---|---|---|---|---|---|---|---|---|---|---|---|---|---|---|---|
| | | | | | | | | | | Left- | Right- | | Left- | | | | | trans- |
| | | | | | | | | | | hand | hand | | hand | | | Ac₁ | Ac₃ | for- |
| | | | | | | | | | | side | side | | side | | | trans- | trans- | ma- |
| | | | | | | | | | | of | of | | of | | | for- | for- | tion |
| | | | | | | | | | | Ine- | Ine- | | Ine- | | | ma- | ma- | point - |
| | | | | | | | | | | qual- | qual- | | qual- | | | tion | tion | T1 × |
| Steel | Components (% by mass) | | | | | | | | | ity | ity | | ity | | | point | point | T2 |
| No. | C | Si | Mn | P | S | Al | N | Cr | Others | (1) | (1) | C* | (2) | T1 | T2 | (° C.) | (° C.) | (° C.) |
| A | 0.151 | 1.46 | 2.68 | 0.013 | 0.0021 | 0.011 | 0.0051 | 0.01 | — | 1.04 | 0.82 | 0.29 | 342 | 187 | 0.30 | 660 | 826 | 769 |
| B | 0.097 | 1.75 | 2.46 | 0.011 | 0.0015 | 0.019 | 0.0035 | 0.37 | Ti: 0.021, | 0.84 | 0.79 | 0.18 | 380 | 178 | 0.34 | 674 | 852 | 791 |
| | | | | | | | | | B: 0.0019 | | | | | | | | | |
| C | 0.132 | 1.37 | 2.52 | 0.010 | 0.0025 | 0.022 | 0.0039 | 1.01 | — | 1.14 | 0.84 | 0.15 | 377 | 144 | 0.37 | 683 | 831 | 777 |
| D | 0.226 | 1.29 | 1.95 | 0.009 | 0.0012 | 0.015 | 0.0024 | 0.91 | Nb: 0.021 | 1.19 | 0.85 | 0.31 | 346 | 146 | 0.36 | 689 | 791 | 738 |
| E | 0.184 | 2.01 | 2.36 | 0.014 | 0.0010 | 0.024 | 0.0036 | 0.35 | Ti: 0.019, | 1.10 | 0.76 | 0.31 | 333 | 183 | 0.34 | 665 | 843 | 780 |
| | | | | | | | | | B: 0.0012 | | | | | | | | | |
| | | | | | | | | | Ni: 0.31, | | | | | | | | | |
| | | | | | | | | | Cu: 0.22 | | | | | | | | | |
| F | 0.112 | 1.18 | 2.98 | 0.012 | 0.0014 | 0.016 | 0.0044 | 0.52 | Ti: 0.025, | 1.10 | 0.86 | 0.14 | 373 | 161 | 0.33 | 663 | 829 | 775 |
| | | | | | | | | | B: 0.0010 | | | | | | | | | |
| | | | | | | | | | Ca: 0.0022 | | | | | | | | | |
| G | 0.195 | 1.41 | 2.23 | 0.015 | 0.0021 | 0.020 | 0.0035 | 0.21 | — | 1.04 | 0.83 | 0.40 | 318 | 178 | 0.32 | 666 | 812 | 756 |
| H | 0.060 | 0.85 | 3.33 | 0.023 | 0.0009 | 0.022 | 0.0032 | 0.01 | Ti: 0.060, | 0.82 | 0.90 | 0.09 | 386 | 176 | 0.29 | 658 | 842 | 792 |
| | | | | | | | | | B: 0.0032 | | | | | | | | | |
| | | | | | | | | | Nb: 0.081 | | | | | | | | | |
| I | 0.411 | 1.26 | 1.64 | 0.025 | 0.0023 | 0.024 | 0.0039 | 0.01 | — | 1.06 | 0.85 | 0.92 | 162 | 184 | 0.30 | 659 | 714 | 660 |
| J | 0.122 | 0.11 | 2.47 | 0.016 | 0.0021 | 0.018 | 0.0028 | 0.01 | Ti: 0.042, | 0.86 | 0.99 | 0.30 | 343 | 162 | 0.26 | 651 | 786 | 744 |
| | | | | | | | | | B: 0.0011 | | | | | | | | | |
| | | | | | | | | | Nb: 0.042, | | | | | | | | | |
| | | | | | | | | | Mo: 0.20 | | | | | | | | | |
| K | 0.236 | 1.36 | 1.42 | 0.019 | 0.0017 | 0.017 | 0.0037 | 0.30 | Ni: 0.21 | 0.78 | 0.84 | 0.91 | 166 | 173 | 0.32 | 672 | 799 | 744 |
| L | 0.163 | 1.43 | 2.26 | 0.002 | 0.0016 | 0.015 | 0.0045 | 2.30 | — | 1.47 | 0.83 | 0.12 | 373 | 91 | 0.46 | 718 | 817 | 775 |
| M | 0.152 | 1.67 | 3.72 | 0.023 | 0.0009 | 0.022 | 0.0032 | 0.01 | — | 1.45 | 0.80 | 0.16 | 345 | 191 | 0.31 | 650 | 819 | 760 |
| N | 0.118 | 1.18 | 2.73 | 0.016 | 0.0007 | 0.035 | 0.0031 | 0.00 | — | 0.94 | 0.86 | 0.24 | 358 | 182 | 0.30 | 651 | 830 | 776 |
| O | 0.095 | 1.32 | 2.91 | 0.026 | 0.0013 | 0.029 | 0.0032 | 0.00 | Ti: 0.026, | 0.90 | 0.84 | 0.18 | 373 | 185 | 0.30 | 661 | 853 | 798 |
| | | | | | | | | | B: 0.0017 | | | | | | | | | |
| | | | | | | | | | Nb: 0.042 | | | | | | | | | |
| P | 0.111 | 1.58 | 2.46 | 0.014 | 0.0011 | 0.018 | 0.0025 | 0.00 | Ni: 0.12, | 0.82 | 0.81 | 0.29 | 349 | 190 | 0.31 | 664 | 860 | 801 |
| | | | | | | | | | Mo: 0.13 | | | | | | | | | |

TABLE 5

| | | | Annealing conditions | | | | | | | | | |
|---|---|---|---|---|---|---|---|---|---|---|---|---|
| | | | Heating 1 | | Heating 2 | Soaking | | Cooling | | | | |
| Galvanized | | Thick- | Average | Temper- | Average | Temper- | | Average | Stop | Heat- | Alloying | |
| steel sheet | Steel | ness | rate | ature | rate | ature | Time | rate | Temperature | treating | Temperature | |
| No. | No. | (mm) | (° C./s) | (° C.) | (° C./s) | (° C.) | (s) | (° C./s) | (° C.) | time (s) | (° C.) | Remarks |
| 1 | A | 1.6 | 10 | 750 | 1 | 825 | 120 | 15 | 525 | — | 525 | Example of invention |
| 2 | | 1.6 | 3 | 750 | 1 | 825 | 120 | 15 | 525 | — | 525 | Comparative example |
| 3 | | 1.6 | 10 | 750 | 1 | 760 | 120 | 15 | 525 | — | 525 | Comparative example |
| 4 | | 1.6 | 10 | 750 | 1 | 825 | 10 | 15 | 525 | — | 525 | Comparative example |
| 5 | | 1.6 | 10 | 750 | 1 | 825 | 120 | 2 | 525 | — | 525 | Comparative example |
| 6 | | 1.6 | 10 | 750 | 1 | 825 | 120 | 15 | 600 | — | 525 | Comparative example |
| 7 | B | 1.2 | 15 | 750 | 2 | 850 | 90 | 10 | 525 | — | 525 | Example of invention |
| 8 | | 1.2 | 15 | 650 | 2 | 850 | 90 | 10 | 525 | — | 525 | Comparative example |
| 9 | | 1.2 | 15 | 750 | 10 | 850 | 90 | 10 | 525 | — | 525 | Comparative example |
| 10 | | 1.2 | 15 | 750 | 2 | 920 | 90 | 10 | 525 | — | 525 | Comparative example |
| 11 | | 1.2 | 15 | 750 | 2 | 850 | 90 | 10 | 525 | — | 625 | Comparative example |
| 12 | C | 1.6 | 10 | 750 | 1 | 825 | 120 | 15 | 525 | 50 | 525 | Example of invention |
| 13 | | 1.6 | 10 | 750 | 1 | 780 | 120 | 15 | 525 | 50 | 525 | Example of invention |
| 14 | D | 2.3 | 8 | 750 | 1 | 780 | 150 | 6 | 525 | — | — | Example of invention |
| 15 | E | 1.6 | 10 | 750 | 1 | 825 | 120 | 10 | 525 | — | 525 | Example of invention |
| 16 | F | 1.2 | 15 | 750 | 2 | 800 | 90 | 15 | 525 | — | 525 | Example of invention |
| 17 | G | 1.6 | 10 | 750 | 1 | 800 | 120 | 15 | 525 | — | 525 | Comparative example |
| 18 | H | 1.2 | 15 | 750 | 2 | 800 | 90 | 15 | 525 | — | 525 | Comparative example |
| 19 | I | 1.6 | 10 | 750 | 1 | 700 | 120 | 10 | 525 | — | 525 | Comparative example |
| 20 | J | 1.2 | 15 | 750 | 2 | 750 | 90 | 10 | 525 | — | 525 | Comparative example |
| 21 | K | 2.3 | 8 | 750 | 1 | 780 | 150 | 6 | 525 | — | 525 | Comparative example |
| 22 | L | 1.6 | 10 | 750 | 1 | 800 | 120 | 15 | 525 | 50 | — | Comparative example |
| 23 | M | 1.2 | 15 | 750 | 2 | 800 | 90 | 15 | 525 | — | 525 | Comparative example |
| 24 | N | 1.2 | 15 | 750 | 2 | 800 | 120 | 15 | 525 | — | 525 | Example of invention |
| 25 | O | 1.6 | 10 | 750 | 1 | 825 | 120 | 10 | 525 | — | 525 | Example of invention |
| 26 | P | 1.6 | 10 | 750 | 1 | 825 | 120 | 10 | 525 | 50 | 525 | Example of invention |

TABLE 6

| | Microstructure* | | | | | | | | | | | | |
|---|---|---|---|---|---|---|---|---|---|---|---|---|---|
| | | | | | | Area | | | | | | | |
| | | | | | | fraction | | | | | | | |
| | | | | | | of M | | | | | | | |
| Galva- | | | | | | having | | | | | | | |
| nized | Area | Area | | Average | Area | a grain | | | | | | Critical | |
| steel | fraction | fraction | Area of | grain size | fraction of | size of | Hardness | Tensile properties | | | | bend | |
| sheet | of F | of M | M/Area | of M | tempered | 1 μm or | ratio | TS | El | TS × El | λ | radius/ | |
| No. | (%) | (%) | of F | (μm) | M (%) | less (%) | (M/F) | (MPa) | (%) | (MPa · %) | (%) | thickness | Remarks |
| 1 | 61 | 39 | 0.64 | 2.7 | 71 | 27 | 2.34 | 1241 | 16.7 | 20725 | 36 | 0.6 | Example of invention |
| 2 | 69 | 31 | 0.45 | 1.8 | 17 | 18 | 3.18 | 1154 | 15.1 | 17425 | 16 | 2.3 | Comparative example |
| 3 | 71 | 29 | 0.41 | 1.6 | 0 | 36 | 3.70 | 1136 | 16.4 | 18630 | 10 | 2.2 | Comparative example |
| 4 | 52 | 48 | 0.92 | 1.4 | 18 | 45 | 3.08 | 1310 | 11.3 | 14803 | 12 | 2.2 | Comparative example |
| 5 | 75 | 25 | 0.33 | 1.8 | 2 | 41 | 4.26 | 1146 | 16.1 | 18451 | 11 | 2.2 | Comparative example |
| 6 | 62 | 23 | 0.37 | 2.2 | 15 | 12 | 3.48 | 1096 | 15.1 | 16550 | 28 | 2.0 | Comparative example |
| 7 | 66 | 34 | 0.52 | 2.9 | 85 | 10 | 1.86 | 1189 | 17.2 | 20451 | 46 | 0.8 | Example of invention |
| 8 | 73 | 27 | 0.37 | 1.7 | 16 | 50 | 3.51 | 1062 | 17.3 | 18373 | 12 | 2.1 | Comparative example |
| 9 | 60 | 40 | 0.67 | 1.5 | 15 | 48 | 3.29 | 1180 | 14.1 | 16638 | 15 | 2.5 | Comparative example |
| 10 | 21 | 79 | 3.76 | 2.6 | 95 | 20 | 2.08 | 1140 | 13.8 | 15732 | 10 | 2.5 | Comparative example |
| 11 | 66 | 24 | 0.36 | 2.7 | 3 | 21 | 3.03 | 1046 | 12.5 | 13075 | 13 | 2.1 | Comparative example |
| 12 | 55 | 45 | 0.82 | 3.0 | 84 | 27 | 2.21 | 1241 | 16.3 | 20228 | 39 | 0.9 | Example of invention |
| 13 | 68 | 32 | 0.47 | 3.0 | 60 | 27 | 2.38 | 1182 | 16.9 | 19976 | 33 | 0.9 | Example of invention |
| 14 | 59 | 41 | 0.69 | 2.5 | 66 | 21 | 2.45 | 1445 | 13.2 | 19074 | 45 | 0.9 | Example of invention |
| 15 | 60 | 40 | 0.67 | 3.1 | 78 | 21 | 2.33 | 1240 | 16.8 | 20832 | 40 | 0.9 | Example of invention |
| 16 | 42 | 58 | 1.38 | 3.4 | 86 | 22 | 2.16 | 1235 | 16.2 | 20007 | 52 | 0.8 | Example of invention |
| 17 | 55 | 45 | 0.82 | 3.7 | 0 | 15 | 4.51 | 1245 | 13.2 | 16434 | 15 | 2.0 | Comparative example |
| 18 | 33 | 67 | 2.03 | 1.6 | 0 | 43 | 4.30 | 1270 | 11.4 | 14478 | 9 | 2.9 | Comparative example |
| 19 | 58 | 42 | 0.72 | 2.8 | 0 | 18 | 4.47 | 1510 | 10.1 | 15251 | 8 | 2.2 | Comparative example |
| 20 | 39 | 61 | 1.56 | 3.3 | 74 | 17 | 2.19 | 1212 | 12.8 | 15514 | 18 | 2.1 | Comparative example |
| 21 | 77 | 23 | 0.30 | 2.9 | 11 | 12 | 3.66 | 1145 | 16.3 | 18664 | 10 | 2.1 | Comparative example |
| 22 | 26 | 74 | 2.85 | 3.4 | 19 | 27 | 4.26 | 1234 | 11.8 | 14561 | 38 | 0.9 | Comparative example |
| 23 | 38 | 62 | 1.63 | 2.7 | 5 | 14 | 3.78 | 1239 | 11.8 | 14620 | 34 | 1.3 | Comparative example |
| 24 | 65 | 35 | 0.54 | 3.6 | 90 | 15 | 2.36 | 1195 | 16.2 | 19359 | 48 | 0.9 | Example of invention |
| 25 | 61 | 39 | 0.64 | 3.2 | 87 | 11 | 2.06 | 1241 | 15.8 | 19608 | 41 | 0.9 | Example of invention |
| 26 | 59 | 41 | 0.69 | 2.6 | 82 | 24 | 2.29 | 1260 | 15.1 | 19026 | 45 | 1.3 | Example of invention |

*F represents a ferritic phase and M represents a martensitic phase.

1. A high-strength cold-rolled steel sheet having excellent formability, comprising 0.05% to 0.3% C, 0.5% to 2.5% Si, 1.5% to 3.5% Mn, 0.001% to 0.05% P, 0.0001% to 0.01% S, 0.001% to 0.1% Al, 0.0005% to 0.01% N, and 1.5% or less Cr (including 0%) on a mass basis, the remainder being Fe and unavoidable impurities; satisfying Inequalities (1) and (2) below; and containing a ferritic phase and a martensitic phase, an area fraction of the martensitic phase in a microstructure being 30% or more, a quotient (an area occupied by the martensitic phase)/(an area occupied by the ferritic phase) being greater than 0.45 to less than 1.5, an average grain size of the martensitic phase being 2 μm or more:
[C]^{1/2}×([Mn]+0.6×[Cr])≧1−0.12×[Si] (1)
and
550−350×C*−40×[Mn]−20×[Cr]+30×[Al]≧340 (2)
where C*=[C]/(1.3×[C]+0.4×[Mn]+0.45×[Cr]−0.75), [M] represents the content (% by mass) of an element M, and [Cr]=0 when the content of Cr is 0%.

2. The cold-rolled steel sheet according to claim 1, having a quotient (hardness of the martensitic phase)/(hardness of the ferritic phase) of 2.5 or less.

3. The cold-rolled steel sheet according to claim 1, wherein the area fraction of a martensitic phase having a grain size of 1 μm or less in the martensitic phase is 30% or less.

4. The cold-rolled steel sheet according to claim 1, wherein the content of Cr is 0.01% to 1.5% on a mass basis.

5. The cold-rolled steel sheet according to claim 1, further comprising at least one of 0.0005% to 0.1% Ti and 0.0003% to 0.003% B on a mass basis.

6. The cold-rolled steel sheet according to claim 1, further comprising 0.0005% to 0.05% Nb on a mass basis.

7. The cold-rolled steel sheet according to claim 1, further comprising at least one selected from the group consisting of 0.01% to 1.0% Mo, 0.01% to 2.0% Ni, and 0.01% to 2.0% Cu on a mass basis and satisfying Inequality (3) below instead of Inequality (2):
550−350×C*−40×[Mn]−20×[Cr]+30×[Al]−10×[Mo]−17×[Ni]−10×[Cu]≧340 (3)
where C*=[C]/(1.3×[C]+0.4×[Mn]+0.45×[Cr]−0.75), [M] represents the content (% by mass) of an element M, and [Cr]=0 when the content of Cr is 0%.

8. The cold-rolled steel sheet according to claim 1, further comprising 0.001% to 0.005% Ca on a mass basis.

9. A high-strength galvanized steel sheet having excellent formability, comprising 0.05% to 0.3% C, 0.5% to 2.5% Si, 1.5% to 3.5% Mn, 0.001% to 0.05% P, 0.0001% to 0.01% S, 0.001% to 0.1% Al, 0.0005% to 0.01% N, and 1.5% or less Cr (including 0%) on a mass basis, the remainder being Fe and unavoidable impurities; satisfying Inequalities (1) and (2) below; and containing a ferritic phase and a martensitic phase, an area fraction of the martensitic phase in a microstructure being 30% or more, a quotient (an area occupied by the martensitic phase)/(an area occupied by the ferritic phase) being greater than 0.45 to less than 1.5, an average grain size of the martensitic phase being 2 μm or more:
[C]^{1/2}×([Mn]+0.6×[Cr])≧1−0.12×[Si] (1)
and
550−350×C*−40×[Mn]−20×[Cr]+30×[Al]≧340 (2)
where C*=[C]/(1.3×[C]+0.4×[Mn]+0.45×[Cr]−0.75), [M] represents the content (% by mass) of an element M, and [Cr]=0 when the content of Cr is 0%.

10. The galvanized steel sheet according to claim 9, having a quotient (hardness of the martensitic phase)/(hardness of the ferritic phase) of 2.5 or less.

11. The galvanized steel sheet according to claim 9, wherein the area fraction of a martensitic phase having a grain size of 1 μm or less in the martensitic phase is 30% or less.

12. The galvanized steel sheet according to claim 9, wherein the content of Cr is 0.01% to 1.5% on a mass basis.

13. The galvanized steel sheet according to claim 9, further comprising at least one of 0.0005% to 0.1% Ti and 0.0003% to 0.003% B on a mass basis.

14. The galvanized steel sheet according to claim 9, further comprising 0.0005% to 0.05% Nb on a mass basis.

15. The galvanized steel sheet according to claim 9, further comprising at least one selected from the group consisting of 0.01% to 1.0% Mo, 0.01% to 2.0% Ni, and 0.01% to 2.0% Cu on a mass basis and satisfying Inequality (3) below instead of Inequality (2):
550−350×C*−40×[Mn]−20×[Cr]+30×[Al]−10×[Mo]−17×[Ni]−10×[Cu]≧340 (3)
where C*=[C]/(1.3×[C]+0.4×[Mn]+0.45×[Cr]−0.75), [M] represents the content (% by mass) of an element M, and [Cr]=0 when the content of Cr is 0%.

16. The cold-rolled steel sheet according to claim 9, further comprising 0.001% to 0.005% Ca on a mass basis.

17. The galvanized steel sheet according to claim 9, having a zinc coating which is an alloyed zinc coating.

18. A method for manufacturing a high-strength cold-rolled steel sheet having excellent formability comprising:
annealing a steel sheet containing the components specified in claim 1 such that the steel sheet is heated to a temperature not lower than the Ac₁ transformation point thereof at an average heating rate of 5° C./s or more;
further heating to a temperature not lower than (Ac₃ transformation point−T1×T2)° C. at an average heating rate of less than 5° C./s;
soaking at a temperature not higher than the Ac₃ transformation point thereof for 30 s to 500 s; and
cooling to a cooling stop temperature of 600° C. or lower at an average cooling rate of 3° C./s to 30° C./s, wherein T1=160+19×[Si]−42×[Cr], T2=0.26+0.03×[Si]+0.07×[Cr], [M] represents the content (% by mass) of an element M, and [Cr]=0 when the content of Cr is 0%.

19. The method according to claim 18, wherein the annealed steel sheet is heat-treated at a temperature of 300° C. to 500° C. for 20 s to 150 s before the annealed steel sheet is cooled to room temperature.

20. A method for manufacturing a high-strength galvanized steel sheet having excellent formability comprising:
annealing a steel sheet containing the components specified in claim 9 such that the steel sheet is heated to a temperature not lower than the Ac₁ transformation point thereof at an average heating rate of 5° C./s or more;
further heating to a temperature not lower than (Ac₃ transformation point−T1×T2)° C. at an average heating rate of less than 5° C./s;
soaking at a temperature not higher than the Ac₃ transformation point thereof for 30 s to 500 s;
cooling to a cooling stop temperature of 600° C. or lower at an average cooling rate of 3° C./s to 30° C./s; and
galvanizing the steel sheet by hot dipping, wherein T1=160+19×[Si]−42×[Cr], T2=0.26+0.03×[Si]+0.07×[Cr], [M] represents the content (% by mass) of an element M, and [Cr]=0 when the content of Cr is 0%.

21. The method according to claim 20, wherein the annealed steel sheet is heat-treated at a temperature of 300° C. to 500° C. for 20 s to 150 s before the annealed steel sheet is galvanized.

22. The method according to claim 20, wherein a zinc coating is alloyed at a temperature of 450° C. to 600° C. subsequent to hot dip galvanizing.
